(19) United States
(12) Patent Application Publication
(10) Pub. No.: US 2023/0065423 A1
(43) Pub. Date: Mar. 2, 2023

(54) APPARATUS FOR REMOVAL OF IN SOIL EMBEDMENT AND METHOD OF CONSTRUCTION THEREOF

(71) Applicant: Israel FEIG, Haifa (IL)

(72) Inventor: Israel FEIG, Haifa (IL)

(21) Appl. No.: 17/887,088

(22) Filed: Aug. 12, 2022

Related U.S. Application Data
(60) Provisional application No. 63/232,169, filed on Aug. 12, 2021.

(30) Foreign Application Priority Data
Apr. 13, 2022 (IL) 292214

(51) Int. Cl. A01G 23/04; A01C 11/00

(52) U.S. Cl. CPC A01G 23/043; A01C 11/00

(57) ABSTRACT

An apparatus is provided for removal of in soil embedded item(s), such as one or more trees and/or solid items. The apparatus comprises an interstice tool having a cutting mechanism for cutting an interstice in a mass of soil which is surrounded by a trench having a trench bottom on which the mass of soil is disposed. The interstice tool is configured to cut the interstice to liberate a selected volume of soil containing the embedded item(s), and to build a platform in the interstice to support the liberated selected volume thereon. Once the selected volume of soil and/or item(s) is/are cut and supported on the platform, these may be hoisted away by use of hoisting equipment, for removal and relocation. The apparatus may also be used to pass devices like pipes, cables, and the like, through the interstice.

### CROSS-REFERENCE TO RELATED APPLICATIONS

The present Application claims priority of U.S. Provisional Patent Application No. 63/232,169, filed Aug. 12, 2021, and from Israeli Patent Application No. 292214 filed Apr. 13, 2022, the entire contents of which are incorporated herein by reference.

### FIELD OF THE INVENTION

The present disclosure refers to the environment friendly removal and relocation of trees, but is also advantageous for the removal of in soil partially or totally embedded item(s). Such removal may be advantageous not only for trees but also for delicate items necessary to be removed from the soil undamaged, like fragile archeological objects, and dangerous explosive devices.

### SUMMARY

An apparatus is provided for removal of in soil embedded item(s), such as trees. The apparatus comprises an interstice tool configured to support a cutting mechanism. The cutting mechanism is configured to cut an interstice in a mass of soil, including the item(s). The mass of soil is encompassed by a trench having a trench bottom depth on which the mass of soil is supported, and the interstice is cut a cut depth selected below top soil level and above the trench bottom depth. Furthermore, the interstice tool is configured to insert an implement(s) into and throughout of the interstice.

The interstice tool is further configured to either build a platform in the interstice, to support the volume thereon, or to provide a channeling passage in the interstice.

There is also provided a method for construction of an apparatus for removal of in soil embedded item(s). The method comprises the assembly of four beams into a right-angled quadrilateral shape, to form a support and guidance structure for disposition at a bottom depth of a trench. The trench is compliant with the shape of the guidance structure, and flanks a mass of soil, which is disposed at the bottom depth. The guidance structure supports a tool carriage whereon an interstice tool is supported in bridging disposition over two parallel beams.

The interstice tool is further provided with a cutting mechanism, for cutting through soil and item(s) matter, and form an interstice. The interstice is cut at a trench cut depth, which is disposed higher up above the trench depth, to cut a bottom surface. The bottom surface separates apart between a volume of soil and the mass. Next, a carriage tractor is mounted on one of two parallel beams, and is coupled to the tool carriage for driving the interstice tool in cutting translation. The translation of the interstice tool is operated for intermittently cutting and inserting implements in the interstice. The insertion of implements forms either a support platform for removal and hoisting away of the volume, or a channeling passage.

### Technical Problem

The problem of removal of in soil embedded item(s) may be one of preventing damage thereto, thus by retrieval thereof intact or unharmed after excavation. However, the problem may also be one of limitation of the damage caused, to a predetermined level which is acceptable for practical purposes. Contrary thereto, the felling of a tree for removal thereof is not considered as being environment friendly.

### Solution to the Problem

Still with the example of removal of a tree, the environmental friendly solution calls for removal of the tree together with a mass of soil and with an a priori selected amount of tree roots, in a manner which will ensure a successful reimplantation at a different site. The same solution may also be applied to the partial or complete removal of item(s) that are embedded, either protruding out and above top soil level or not, which item(s) may be made of and/or include matter or materials such as tree roots, soil, wood, rocks, concrete, steel, stones as well as other materials.

To this end there are provided an apparatus and a method adapted to cut away and release a volume of soil which envelopes the embedded item(s) or a desired portion thereof. Next, a platform is built under the from the retaining soil to be released volume of soil, and thereafter, the platform supporting the volume of soil and the therein contained items(s) may be hoisted away. Alternatively, a channeling passage is disposed under the volume.

### Advantageous Effects of Invention

One advantage allows to retrieve an embedded item or item(s) or a desired portion of the embedded item(s) thereof, in integrity. With a tree, the main advantage is to prevent damage thereto and permit a successful reimplantation at a selected different location.

Another advantage is the ability to cut away and remove a totally underground buried and embedded item or item(s), or a chosen portion thereof.

Furthermore, the capability of the apparatus to build a support platform by insertion of implements in an interstice cut open in the soil may be advantageous for providing a channeling passage for ducts, pipes, tubes, cables, wiring, and thereto similar articles.

### BRIEF DESCRIPTION OF DRAWINGS

Non-limiting embodiments of the invention will be described with reference to the following description of exemplary embodiments, in conjunction with the figures. The figures are generally not shown to scale and any measurements are only meant to be exemplary and not necessarily limiting. In the figures, identical structures, elements, or parts that appear in more than one figure are preferably labeled with a same or similar number in all the figures in which they appear, in which:

FIGS. 1 and 2 illustrate an item embedded in a volume of soil which is flanked by an encompassing trench,

FIG. 3 depicts an exemplary embodiment of links of an endless chain,

FIG. 4 shows an exemplary cutting mechanism,

FIG. 5 illustrates, in block diagram form, elements of the cutting drive,

FIG. 6 is a top view of FIG. 1,

FIG. 7 depicts a cross-section taken along a cut B-B of FIG. 6,

FIGS. 8 and 9 illustrate a trailed cart,

FIG. 10 is a schematic top view of a portion of the apparatus,

FIG. 11 is a schematic partial cross-section of FIG. 10,

FIG. 12 is a cross-section through item(s) and the trench 30,

FIGS. 13 to 16 and 16A depict a mat building sequence,

FIG. 17 illustrates an exemplary embodiment of an implement 60,

FIG. 18 is a schematic illustration related to the insertion of an implement 60,

FIG. 19 depicts the coupling of an implement to the endless chain,

FIG. 20 illustrates an exemplary embodiment of a belt,

FIG. 21 is a cross-section of an implement in an interstice,

FIG. 22 illustrates a volume of soil hoisted by a hoisting machine,

FIG. 23 is a is a block diagram of the power unit, and

FIG. 24 is a block diagram illustrating elements of the apparatus APP.

### DETAILED DESCRIPTION

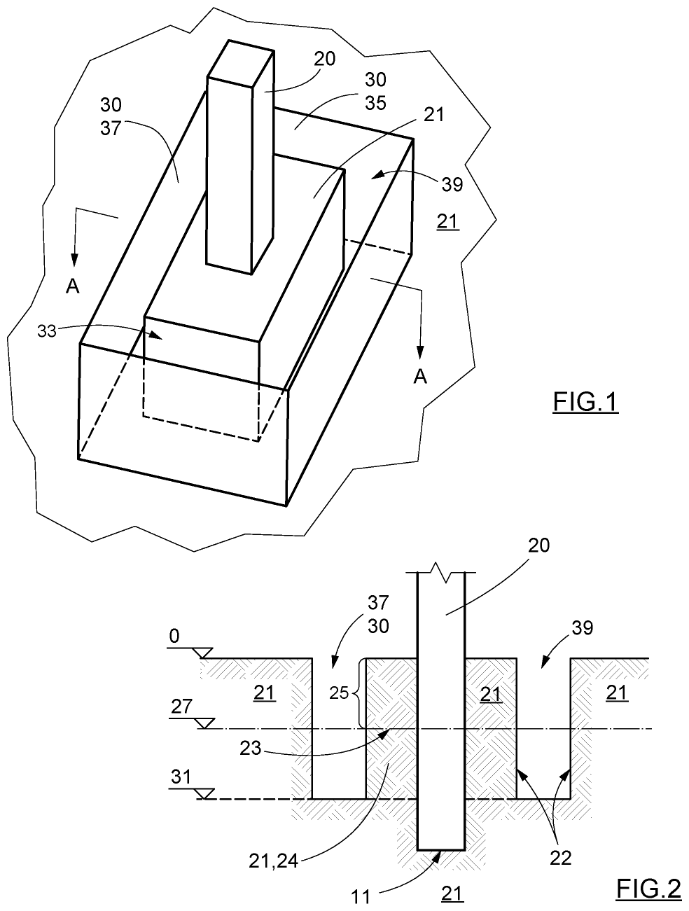

FIGS. 1 and 2 are a schematic illustration for the sake of orientation. FIG. 1 shows an item 20 which is embedded in a soil 21, and FIG. 2 is a cross-section taken along the plane A-A indicated in FIG. 1. The wording ‘embedded in a soil’ is accepted to mean ‘having at least a portion thereof embedded in the soil.

FIGS. 1 and 2 depicts an item 20 which is embedded in a soil 21, and is encompassed, which means included, contained, and surrounded by a trench 30. For example, a right-angled quadrilateral trench 30, which preferably has approximate or quasi vertical walls 22, and a trench bottom depth 31, deeper down below the top soil level 0. Thereby, the item 20 remains embedded in soil 21, formed as a block or mass of soil 24. The block of soil 24 is thus surrounded by the trench 30 from the trench top level 0 to the trench bottom depth 31.

To liberate the item 20, entirely or a portion thereof, together with surrounding soil 21, it suffices to cut away a volume 25 of soil 21 from the mass of soil 24, at a selected depth of cut 27, shown in FIG. 2. The selected depth of cut 27 is disposed lower down in the trench 30 than the trench top level 0, but higher up above the trench bottom depth 31. Thus, to liberate the item 20 in entirety, the depth of cut 27 has to be selected deeper down than the in FIG. 2 shown bottom depth 11 of the item 20.

To cut away a selected volume 25 of soil 21, an interstice tool 400, described hereinbelow and shown in FIG. 5, is disposed in the trench 30 and is operated to cut and open an interstice 50 shown in FIGS. 13 to 16 and 16A, at the appropriately selected depth of cut 27. The depth of cut 27 of the interstice 50 is disposed below the soil top level 0 and above the bottom depth 31 of the trench 30. The interstice 50 cut in the mass of soil 24 thus creates a bottom surface 23 which delimits the volume 25 of soil 21 from the therebelow retaining soil 21, and permits liberation and removal therefrom. In other words, the interstice 50 cuts the by the trench 30 encompassed mass of soil 24 into a volume 25 of soil 21 which is disposed higher up and above a bottom portion of the mass of soil 24.

In FIG. 2, the depth of the trench bottom 31 of the trench 30 is clearly shown to be disposed deeper down into the soil 21, thus deeper down and away from the top soil level 0, than the selected depth of the cut level 27.

To liberate the volume 25 shown in FIG. 2, the interstice tool 400 may be operated to cut, for example, from a trench first side 33, through the mass of soil 24, and out in a trench second side 35, which is disposed opposite the trench first side 33. Thereby, the in the soil 21 embedded item 20 may be liberated from the soil 21 below the cut level 27, by an interstice 50, whereby the from the soil 21 released item 20 may be hoisted away together with the volume 25 of soil 21.

In FIG. 5, the interstice tool 400 is shown to include a cutting drive 300, a cutting mechanism 200, and an endless chain 100. The cutting mechanism 200 supports the endless chain 100 which is configured to cut through soil 21 and matter 29 from which one or more items 20 are made.

### The Endless Chain

The principle of operation of driven endless chains coupled to sprocket wheels is well known to those skilled in the art and is therefore not described in detail.

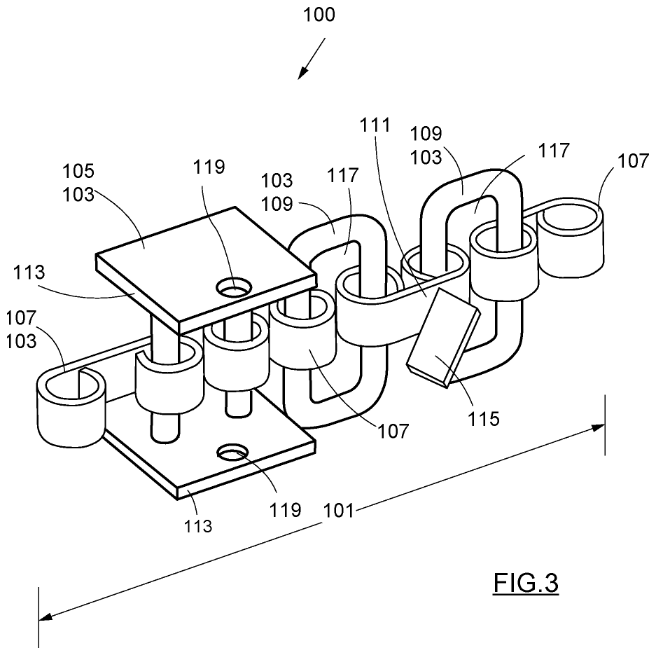

FIG. 3 illustrates an exemplary embodiment of one chain section 101 of the endless chain 100 for cutting item(s) made of matter or material 29. Chain sections 101 may support various types of links 103 which are disposed in repetitive succession along the cutting chain 100. For example, each one section 101 of links 103 may start with and include a cutting link 105, a coupling link 107, an open link 109, a clearing link 111, again an open link 109, and end with a coupling link 107. The type of links 103 supported in a section of links 101 may be the same or different from each other and each one chain section 101 of links 103 may be identical or different from another section 101, and support more or less of links of the same type. Each one chain section 101 of links 103 may support a string of links 103 disposed in a same or in a different combination. The type of links 103 and their number in a section of links 101 may be selected as practical for the task at hand, for cutting as well as for the introduction of implements 60 in the interstice 50 for building a platform 800, as described hereinbelow.

Although not described in detail for the sake of brevity, each one of the various types of links 103 may be pivotally coupled relative to another type or same type of links 103, and to a preceding and to a following link 103. The same pivotally coupling is true for links 103 pertaining to different sections of links 101. For example, a coupling link 107 may be pivotally coupled to a cutting link 105, to an open link 107, and to a clearing link 111.

A cutting link 105 may include one or more cutting teeth 113, and FIG. 3 depicts two cutting teeth 113. A clearing link 111 may support one or more clearing teeth 115, although only one clearing tooth 115 is shown in FIG. 3.

It is noted that the links 103 have a drive opening 117 which is configured to engage driven sprocket wheels 201, as described hereinbelow. Furthermore, a cutting link 105 may support at least one pull opening 119 opened in at least one cutting tooth 113. The successive links 103 may thus form a flexible endless chain 100 which is configured to cut soil 21 and item's matter 29 by use of the cutting teeth 105, and is further configured for clearing away debris of cut-away matter 29 out of the interstice 50 by use of the at least one clearing tooth 115. Such flexible endless chain 100 is thus constructed to cut and open an interstice 50.

As well known in the art, a cutting tooth 113 of a cutting link 105 may be made of heath threated steel grade able to cut through matter 29 such as stone, rocks, concrete, and even steel, according to knowledge acquired for example, with tunneling machines.

### The Cutting Mechanism

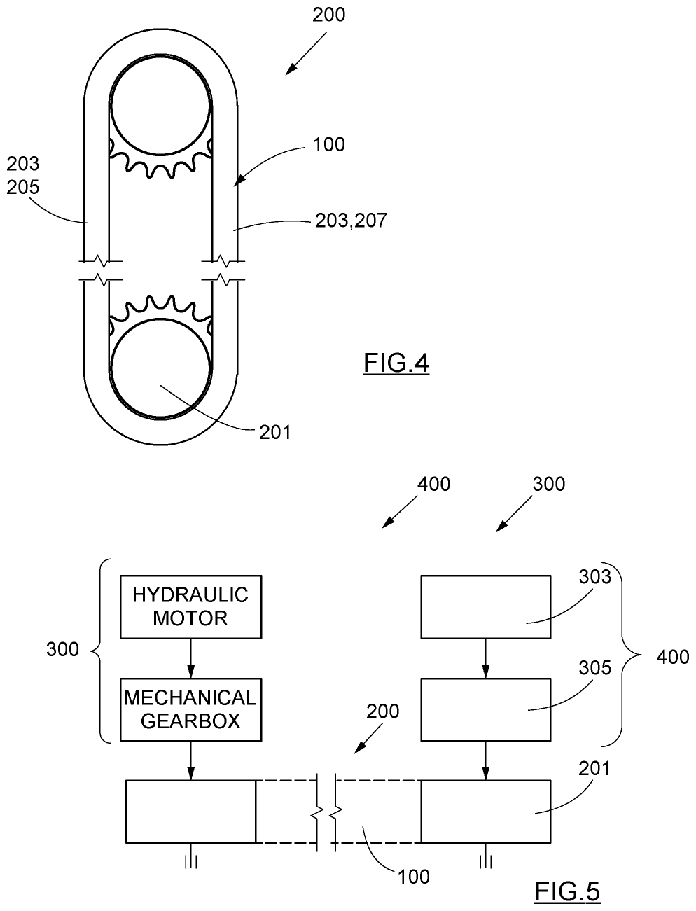

FIG. 4 schematically depicts an exemplary embodiment of a cutting mechanism 200 including two sprocket wheels 201 about which the endless chain 100 is looped, supported, and stretched. The cutting teeth 113 and the clearing teeth 115, shown in FIG. 3, face away from the sprocket wheels 201, and the endless chain 100 forms two linearly stretched parallel portions or chain flanks 203, wherein one chain flank 203 is a chain leading flank 205, and the other one is a chain trailing flank 207. The chain leading flank 205 which cuts and clears soil 21 and items 20, and clears matter 29 away as debris, is kept in linear traction between the two sprocket wheels 201, and so is the chain trailing flank 207, which is used to build the platform 800, as described hereinbelow.

### The Interstice Tool

FIG. 5 is a schematic exemplary embodiment, in block diagram like form, of elements of an interstice tool 400, including a cutting drive 300, which is the machinery that operates the cutting mechanism 200 that rotates the two sprocket wheels 201 to drive the endless chain 100. FIG. 5 depicts two identical cutting drives 300, one cutting drive 300 for each one sprocket wheel 201. Each one of the two sprocket wheels 201 is driven by a hydraulic motor 303 which is coupled to a mechanical gearbox 305, which in turn, is coupled to a sprocket wheel 201 of the cutting mechanism 200, for driving the chain 100 into motion. Both hydraulic motors 303 are coupled to and fed from a same source of pressurized hydraulic fluid pressure provided by a hydraulic power unit 900, as described hereinbelow.

The use of two hydraulic motors 301 prevents slack of the chain 100, thus provides tensile traction to both endless chains flanks 203, i.e. to the chain leading flank 205 as well as to the chain trailing flank 207. Since the same hydraulic oil pressure is provided to each one of both identical hydraulic motors 303, both operate the same moment of rotation at the same revolutions per minute. However, if desired, a well-known chain tension mechanism, not shown, may be provided.

There has thus been described an interstice tool 400 having a cutting drive 300 operating the cutting mechanism 200 which activates the endless chain 100.

### Cutting Drive Travel

According to the description related to FIGS. 1 and 2, to liberate the volume 25 of soil 21, the apparatus APP has to be configured to operate the interstice tool 400 along a length of travel in translation, stretching from start in a first trench side, cutting through the volume 25 of soil and/or item(s), and exit out into a second trench side which is opposite to the first trench side. According to FIG. 1, this means for example that the cutting drive 300 is operated in the trench first side 33, translated to cut through the mass of soil 24, to finally exit into the trench second side 35. Evidently, the cutting drive 300 could have been disposed appropriately to operate in the opposite direction, thus from the trench second side 35 to the trench first side 33.

For cutting in translation through the volume 25 of soil, there is provided a tool carriage 500 to support the interstice tool 400. The tool carriage 500, is preferably a wheeled tool carriage 500 but may also be a sliding sabot tool carriage 500, although not depicted.

Furthermore, there is provided a carriage tractor 600 to drive and translate the tool carriage 500 into motion along the required distance of travel, and a guidance structure 700 for directional guidance and support of the tool carriage 500 which in turn, supports the interstice tool 400. The guidance structure 700 thus supports the carriage tractor 600 and also guides and supports the interstice tool 400 which comprises the tool carriage 500 and the cutting drive 300.

### The Guidance Structure

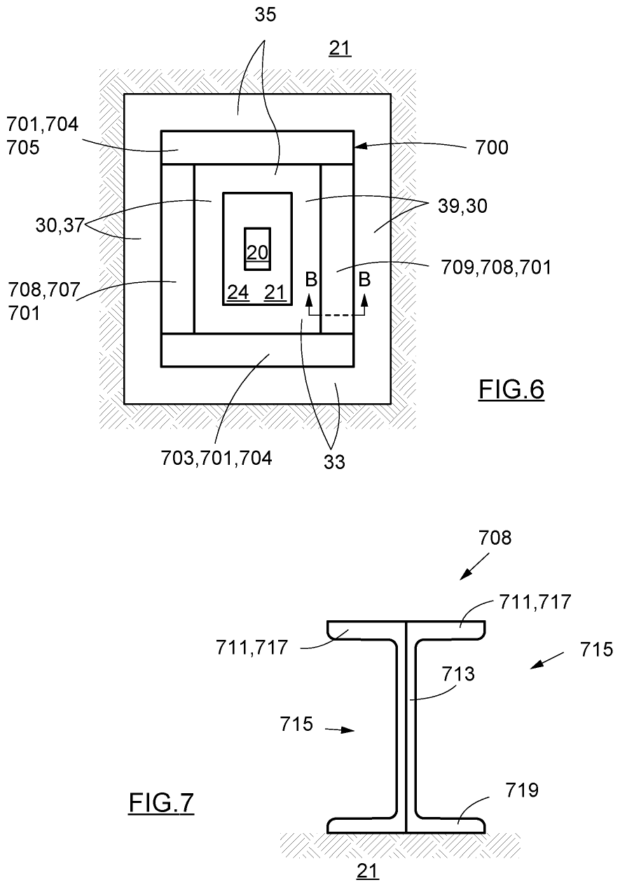

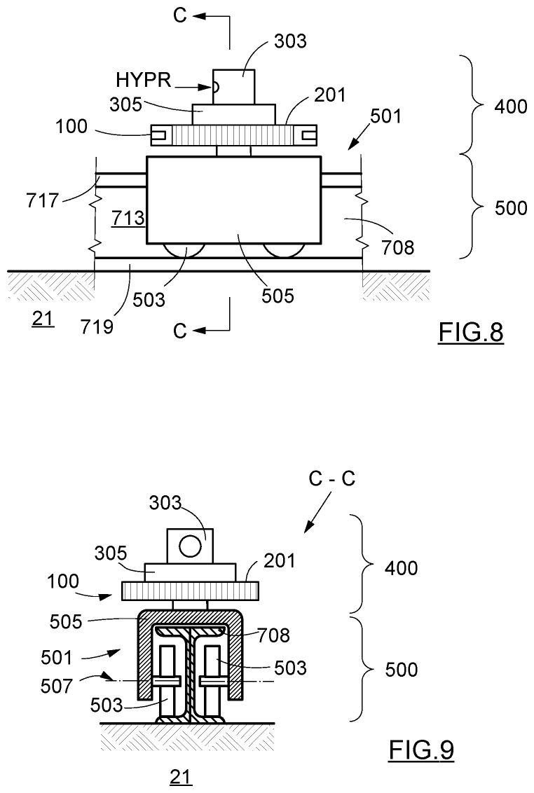

FIG. 6 is a top view of FIG. 1 that illustrates the disposition in the trench 30, and of the guidance structure 700, which may be made as a construction of four beams 701. The four beams 701 may have a footprint shape formed as a rigid right-angled quadrilateral structure, rectangular or square. The four beams 701 may be assembled and disassembled in situ at the bottom depth 31 of the trench 30, and may be used for subsequent and repetitive use. With a rectangular trench 30, the rectangular guidance structure 700 may have a first and a second beam, respectively 703 and 705, which beams are disposed, for example, in the trench first side 33, and in the trench second side 35. In a schematic exemplary embodiment, shown in FIG. 6, the rigid guidance structure 700, shown to form the foundation structure of the apparatus APP. Two beams of the guidance structure 700, respectively 703 and 705, are indicated as lateral beams 704. Likewise, the rectangular guidance structure 700 may have a third and a fourth beam, respectively 707 and 709, which are disposed in the trench third side and in the trench fourth side, respectively 37 and 39. The two third and fourth beams, 707 and 709, are designated as longitudinal beams 708 on which trailed carts 501, shown in FIG. 8, may preferably ride on wheels 503 or be dragged as sabots, which are not shown in the Figs.

FIG. 7 is a cross-section, taken along a cut B-B of FIG. 6, of a longitudinal beam 708 constructed of two sideways disposed bottom-to-bottom coupled U-beams 711. The bottom-to-bottom coupling of the two U-beams 711 forms the web 713 of the two longitudinal I-beams 708, which are disposed on the soil 21 at the bottom depth 31 of the trench 30. The I-beam 708 thus has a vertical web 713 which separates apart between two back-to-back disposed channels 715 forming a top flange 717 and a bottom flange 719. The cross-section of both lateral beams 704 may be identical or different from that of the two longitudinal I-beams 708.

Coupling means of the four beams, i.e. the lateral beams 704 and the longitudinal beams 708, into a rigid quadrangular structure, have to permit ease of assembly and disassembly in situ. Moreover, the four beams have to ensure the rigidity of the guidance structure 700, which when assembled, has to form a sturdy solid and rigid unit. The constructions of such a frame structure prone to disassembly, such as that of the guidance structure 700, are well known to those skilled in the art, and needs therefore not to be detailed.

As described hereinabove with respect to FIG. 2, to liberate the in the soil 21 embedded item 20, it suffices to cut open an interstice 50 at a selected soil cut depth 27, which may be achieved by running the interstice opening tool 400 along the two longitudinal beams 708.

### The Tool Carriage

FIG. 8 illustrates one carriage 500 out of two identical trailed carts 501, i.e. one trailed cart 501 for travelling on one longitudinal beam 708. The description of one of the two trailed carts 501 is also valid for the other trailed cart 501.

FIGS. 8 and 9 illustrate a trailed cart 501 of the tool carriage 500 mounted on one of the longitudinal beams 708, which is configured to support and guide the trailed cart 501 thereon and therealong. FIG. 8 depicts an exemplary embodiment of a trailed cart 501 showing two in tandem disposed cart wheels 503, out of four cart wheels 503. The cart wheels 503 are covered by and support a cart body 505, atop which the interstice tool 400 is supported.

FIG. 9 is a cross-section, taken along a cut C-C shown in FIG. 8, of an exemplary embodiment of a trailed cart 501 mounted on a longitudinal beam 708 of an assembled guidance structure 700. The two side by side disposed couples of tandem wheels 503 ride in the interior of each one channel 715, on the bottom the flange 719 of the longitudinal beam 708. Each pair of the four carriage wheels 503 is coupled to the cart body 505 by a cart wheel axle 507 in freewheeling disposition. Thereby, a trailed cart 501 is firmly guided and limited to motion in one degree of freedom of translation along the longitudinal beam 708.

### Carriage Tractor

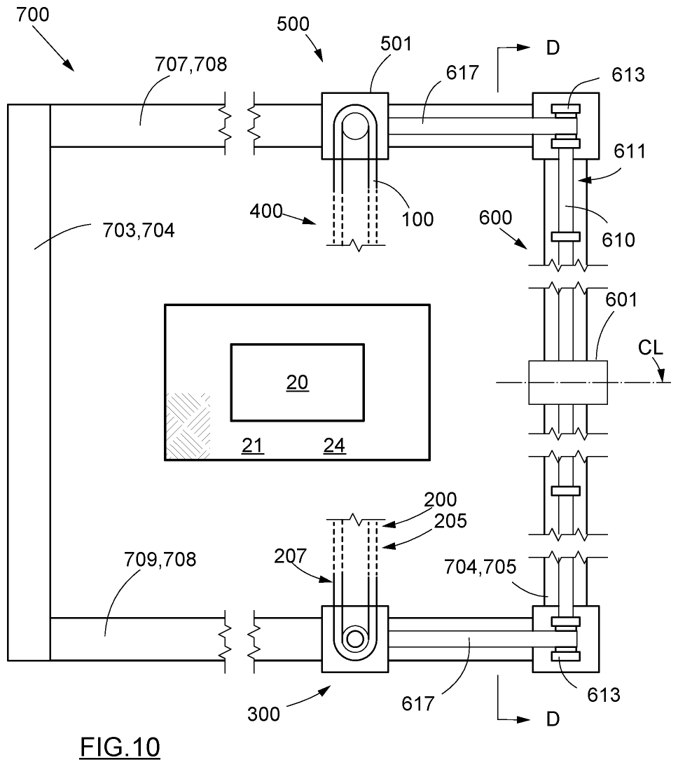

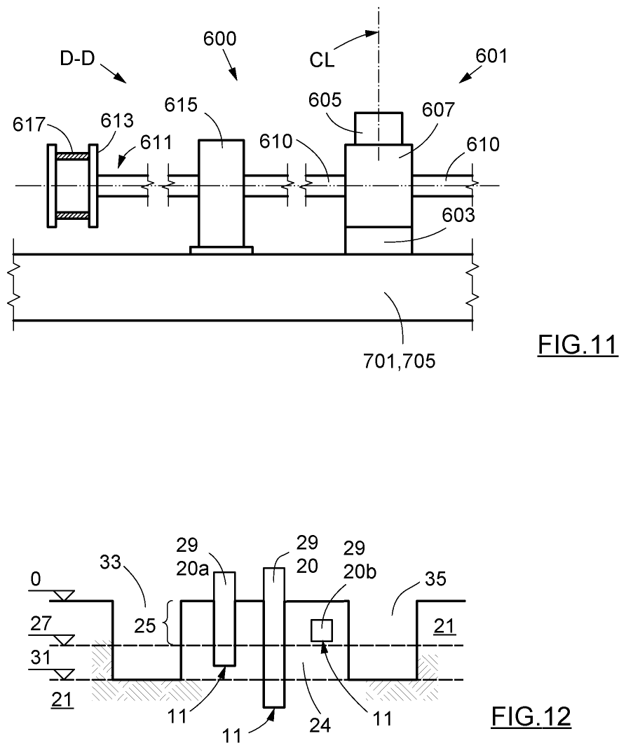

FIGS. 10 and 11 depict the carriage tractor 600, which is operated to drive the tool carriage 500 and supports the interstice tool 400, into linear translation along the longitudinal beam 708. The linear translation covers at least a distance of travel necessary to liberate the item(s) 20, either entirely or in part, together with surrounding soil 21, away from the mass of soil 24, as the volume 25.

FIG. 10 is a schematic top view of an exemplary embodiment of main portions of the apparatus APP, showing the guidance structure 700, the carriage tractor 600, the tool carriage 500, the cutting drive 300 and the cutting mechanism 200. The carriage tractor 600 includes a tractor winch 601, a tractor shaft 610, two tractor drums 613, and two tractor belts 617.

FIG. 11 is a schematic partial cross-section taken along a cut D-D shown in FIG. 10. In view of the symmetry of the carriage tractor 600 about the centerline marked CL, it suffices to describe one portion thereof.

The tractor winch 601 may be disposed on a winch base 603 shown to be supported on a lateral beam 704, here the lateral beam 705 in FIG. 11, and includes a hydraulic tractor motor 605 coupled via a tractor gearbox 607 to a tractor shaft 610. The operation of the hydraulic tractor motor 605 drives the tractor gearbox 607, which rotates the tractor shaft 610. Thereby, the tractor drums 613, one of which is mounted at each one end portion 611 of the tractor shaft 610, are simultaneously driven in rotation. A shaft support 615, mounted on the second beam 704, may be disposed between the tractor winch 601 and the tractor drums 613. When the hydraulic tractor motor 605 is operated, the tractor gearbox 607 rotates the tractor shaft 610 as well as both tractor drums 613.

As best shown on FIG. 10, a tractor belt 617 is wound on each one of the tractor drums 613, and is coupled at one end thereof to a trailed cart 501. Each trailed cart 501 is guided for translation along the longitudinal I-beam 708, and at the other end thereof, is wound on the tractor drum 613. Hence, when driven by the same tractor shaft 610, and when both tractor belts 617 have the same length and appropriate care is taken, both trailed carts 501 will be pulled in unison since both tractor wheels 613 rotate at the same speed of rotation. Thereby, both trailed carts 501 which support the cutting chain 100 therebetween, are configured to maintain the latter parallel to the lateral beams 704. For operation of the interstice tool 400, hydraulic oil pressure has evidently to be provided, by a hydraulic power unit 900, to both the cutting drive 300 and to the hydraulic tractor motor 605, as described hereinbelow.

### The Support Platform

To hoist the volume 25 of soil 21 away out from the therebelow soil 21, for transport and relocation, there is provided a support platform 800 to support the bottom surface 23 of the volume 25. The platform 800 is built and disposed in the interstice 50 opened by the interstice tool 400, and has to cover at least a portion of the bottom surface 23 of the volume 25. For removal away of the volume 25 of soil 21, the platform 800 is provided with appropriate coupling means to fit hoisting equipment.

### The Cut and Build Sequence

It is the interstice tool 400 which fulfills the double task of cutting open an interstice 50 to liberate the volume 25 of soil 21 and to build a support platform 800 to support the volume 25 thereon, for hoisting away. To this end, the interstice tool 400 is configured to operate in successive sequences of two alternating steps: a first step of soil 21 and matter 29 cutting, and a second step of implement(s) 60 insertion(s) for platform mat 800 building.

FIG. 12 is a partial cross-section taken perpendicular to the cut A-A indicated in FIG. 1. The selected depth of cut 27 through the soil 21 and one or more items 20 made of matter 29, is disposed below the top soil level 0 but higher up above the trench bottom depth 31.

FIG. 12 depicts a plurality of items 20, wherein the item marked 20 therein, extends higher up and above the top soil level 0 and reaches deeper down below the trench bottom depth 31. The item 20a extends above the top soil level 0 and ends above the selected depth of cut 27. The item 20b is entirely embedded in the soil 21, below the top soil level 0 and higher up above the selected depth of cut 27.

FIG. 13 is a schematic cross-section detail illustrating an exemplary beginning of the interstice cutting sequence of the interstice tool 400 operated by use of the cutting mechanism 200, a portion of which extends into a trench 30. The cutting mechanism 200 is translated for travel by the tractor winch 601, in a motion starting for example, from the trench first side 33 in direction towards the trench second side 35. The cutting operation of the cutting mechanism 200 penetrates into the mass of soil 24, chain leading flank 205 first, followed by chain trailing flank 207. For the sake of clarity, the chain trailing flank 207 is shown in FIG. 18, but is not in FIGS. 13 to 16 and 16A.

The cutting mechanism 200 cuts, opens, and clears away soil 21 and matter 29 to open an initial interstice 50 portion having a short first span 51 distanced away from the trench first side 33, and is then stopped. The first span 51 of the interstice 50 is selected and commanded to be either short enough to prevent soil 21 to sag in the interstice 50, or as long as still appropriate for the insertion of implements 60 shown in FIG. 14. After the initial step of cutting item(s) and matter 29 operated by the chain leading flank 205, the cutting operation of the interstice tool 400 is thus stopped. At this stage, both the chain leading flank 205 and the chain trailing flank 207 which is not shown, are engaged in the interior of the interstice 50. Next, the chain trailing flank 207 is started to operate for the second step of insertion of implement(s) 60.

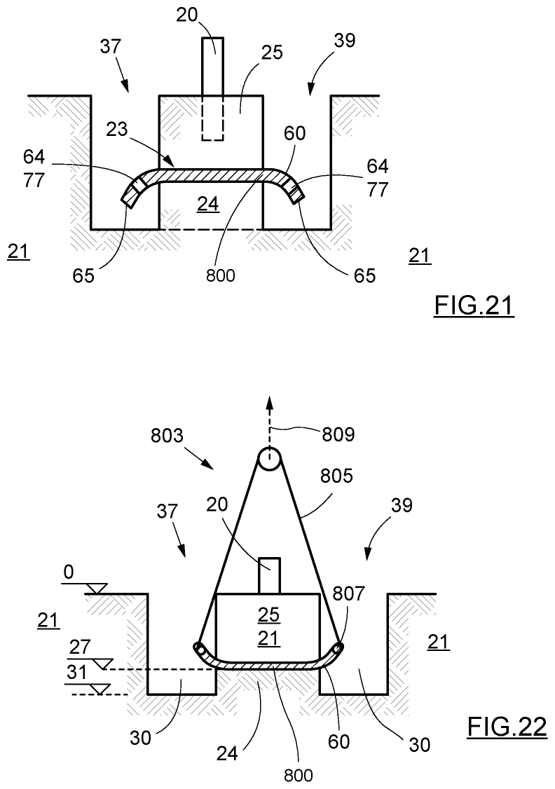

FIG. 14 illustrates a first step of the sequence of steps used to build the support mat 800 shown in FIG. 21.

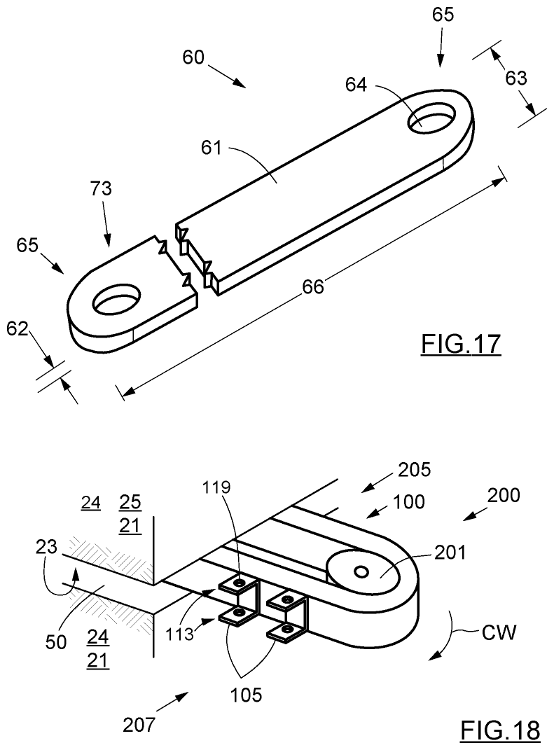

In FIG. 14, as described hereinbelow, use is made of the chain trailing flank 207 to introduce an implement 60, here the first implement 60.1 out of a series of implement 60.i, where i is an integer running from 1 to n. An exemplary implement 60 is shown in FIG. 17, and is described hereinbelow in relation to FIGS. 18 to 21. Such an implement 60 may be selected for example as a strong flexible and pliable object, say a belt 61 having a selected belt width 63, and a belt length 66 extending from in the trench first side 33 and out in the trench second side 35.

In FIG. 15, the cutting mechanism 200 is shown to have cut a second span of interstice length 53 in a second alternating step of matter 29 cutting. Again, the cutting mechanism 200 has been translated for travel by the tractor winch 601, in motion starting from the trench first side 33 in direction towards the trench second side 35, and stopped at a second span of interstice length 53. Thereby, a gap 55 has been formed between the disposition of the first implement 60.1 and the trailing flank 207, not shown in FIG. 15, of the endless chain 100.

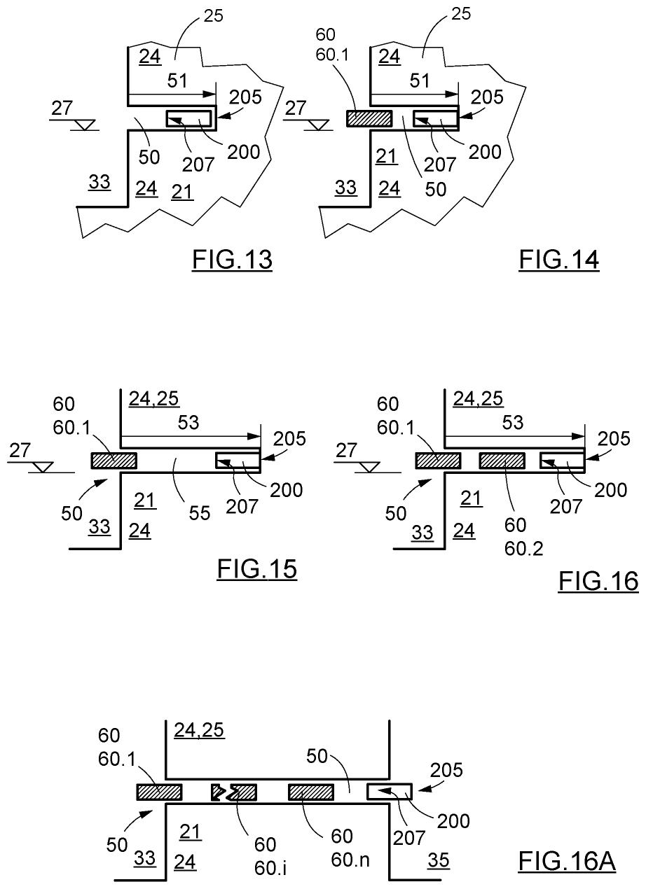

FIG. 16 shows the stopped cutting mechanism 200 at the second span length 53. Like in the first step of the sequence of steps used to build the support mat 800, use is made of the chain trailing flank 207 to introduce and dispose in the interstice 55, between the first implement 60.1 and the chain trailing flank 207, of a second implement 60, here the second implement 60.2. Next, the two steps in successive sequence of two alternating steps of cutting and insertion may be repeated until the interstice device 400 exits out of the interstice 50, in the trench 35. The same process of opening a span length of gap 53 and insertion of an implement 60.i may be repeated until the entire bottom surface 23 of the volume 25, or a portion thereof, is supported.

FIG. 16A depicts the near exit disposition of the cutting mechanism 200, almost out of the interstice 50, whereafter the last implement 60.n was inserted in the interstice 50. Thereby, the succession of implements 60.i has built a support platform 800 or mat 800, under the bottom surface 23 of the volume 25.

FIG. 17 illustrates an exemplary embodiment of the implement 60, which has the general shape of a support belt 61, or belt 61, a plurality of which may be disposed side by side to form the support platform 800, or mat 800. The support belt 61 is long enough to extend across the volume 25 and into the parallel trenches 37 and 39, and may have a belt thickness 62 ranging between 1 mm to 20 mm or more, depending on the belt material. For example, a support belt 61 made from textile or fibers, may have a belt thickness 62 which is thicker than that of a support belt 61 made of a sheet of metal. The belt width 63 may vary for example from 5 cm to 30 cm or more, depending on the type of soil 21.

The support platform 800, or mat 800, may be made from support belts 61 of various materials, in many structures and configurations, appropriate to lift soil 21 and cut items 20, including for example, plain belts 61, belts 61 made of netting, meshed, laced, or perforated material.

FIG. 17 further depicts a support belt 61 with a belt opening 64, shown as a circular bore for the sake of illustration, which belt opening 64 is disposed at each one of both belt ends 65. As described hereinbelow, the belt opening 64 is representative and may be used for the construction of a platform 800 and for being coupled to hoisting ropes 805 for use when hoisting the volume 25.

### Construction of the Platform

The platform 800 may be constructed stepwise, as described hereinabove, by consecutive insertion of an implement 60 in an interstice 50, as depicted in FIGS. 14 to 16A.

FIG. 18 is a schematic isometric illustration of an exemplary portion of the cutting mechanism 200 for cutting open an interstice 50. There is shown the chain trailing flank 207 of the chain 100, but for the sake of clarity, only two cutting links 105 are depicted, wherein each cutting link 105 supports two pull openings 119. These openings 119 are used to drag belts 61 into and through the interstice 50, as described hereinbelow with respect to FIG. 19. The sprocket wheel 201 turns in the clockwise direction CW, as indicated by the arrow marked CW. To insert a belt 61 through an interstice 50, the belt is manually coupled to a cutting link 105 and the cutting mechanism 200 is set in motion to drag the belt 61 from the trench third side 37, through the span of the interstice 50, and then out of the interstice 50, and into the trench fourth side 39.

FIG. 19 is a partial cross-section of a detail used to describe how the belt 61 is coupled to the trailing flank 207 of the chain 100. FIG. 19 depicts a partial cross section of a front view of a cutting link 105 of a trailing flank 207, with two cutting teeth 113, onto which a belt opening 64 of a belt end 65 has been disposed in alignment with the two pull openings 119 of the two cutting teeth 113 of a cutting link 105. Alternatively, the belt opening 64 may be disposed between and in alignment with the two cutting teeth 113 of a cutting link 105, manually inserted implement fastener 70, such as a coupling pin 71, shown as an inverted capital letter L with a short leg 72, and a long leg 73. The short leg 72 is used as a handle, to insert the long leg 73 through the belt opening 64 and through the two pull openings 119 of the cutting link 105. Then the sprocket wheels 201 are set in motion to rotate in the direction indicated by the arrow marked DIR. In turn, the cutting mechanism 200 is translated towards the trench fourth side 39. Thereby, the belt 61 is dragged by a cutting link 105 into the open interstice 50, thus from the side of the trench third side 37 to the side of the thereto opposite trench fourth side 39. Once implement 60, or the belt 61 emerges in the trench fourth side 39, the motion of the cutting chain 100 is stopped. At this stage, both belt ends 65 extend into a trench 30. Thereafter, the coupling pin 71 may be retrieved out of a cutting link 105, whereby the belt 61 is disposed in the interstice 50 and the belt ends 65 are free, out and on the exterior of the interstice 50, in the trenches 37 and 39. Thereby, after the soil 21 and matter 29 of item(s) cutting step, the interstice tool 400 has completed the second step, and of namely the implement 60 insertion step. Hence, the interstice tool 400 has completed the second step, namely the implement 60 insertion step.

The same procedure may be repeated for the insertion of more belts 61, as a plurality of side by side disposed belts 61, to form a support mat 800, which stretches from the trench first side 33 to the trench second side 35.

Usually, after the insertion of a plurality of belts 61i, the platform 800 supports the bottom surface 23 of the volume 25 of soil 21 which contains the item(s) 20, but one belt 61 may also be possible when practical.

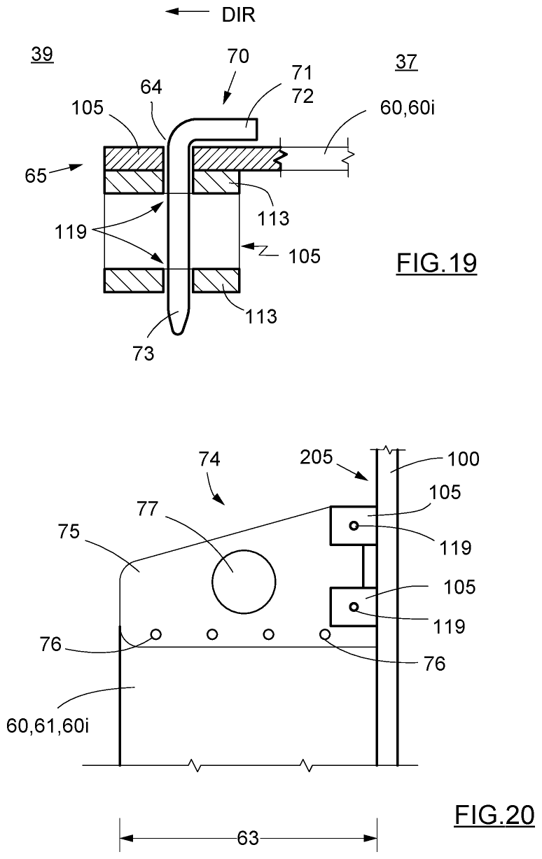

FIG. 20 illustrates an exemplary embodiment of a belt front portion 74 of a belt 61. A leading plate 75, which is coupled to the belt end 65 by mechanical fasteners 76, such as nuts or bolts, is configured to be introduced between the cutting teeth 113 of two cutting links 105 of the trailing flank 207 of a chain 100, as shown in FIG. 20. Alternatively, the leading plate 75 may be supported on top of the two cutting teeth 113. The leading plate 75 has a hoisting opening 77 which may match the pull openings 119 of the cutting links 105. The leading plate 75 may be made of sheet metal, or another rigid material, and may support at least one hoisting opening 77 for coupling to hoisting means, such as a hoisting crane 803 for example.

FIG. 21, like FIG. 2, illustrates a schematic cross-section for the sake of illustration of an exemplary implement 60 of a mat 800 which is inserted in the interstice 50. The belt ends 65, which extend into the trenches 37 and 39, may be picked-up and their belt openings 64, or hoisting openings 77, may be coupled to hoisting equipment 803. Hoisting equipment is well known to those skilled in the art and is therefore neither described nor shown in the Figs. Hoisting equipment 803 and transportation means may be used respectively, for retrieval and relocation of the volume 25 and of the item(s) 20 contained therein. The volume 25 may contain a tree with at least, a portion of the roots.

### Hoisting the Load

FIG. 22 schematically illustrates an exemplary embodiment of a method for removal of the volume 25 out of the soil 21. The volume 25 may be hoisted by a hoisting machine, such as a hoisting crane 803, wherefrom only the hosting ropes 805 and the attachment device 807 are shown. The belt openings 64, or hoisting openings 77, of the implements 60 may be coupled to attachment devices 807 of the hoisting equipment 803, such as shackles or hooks for example. Coupling means for hoisting are commonly well known to those skilled in the art, and therefore, need not to be described in detail. The direction of hoisting the volume 25 is indicated by the arrow marked 809.

The hoisting crane 803 may deposit the volume 25 of soil 21 together with the therein included item(s) 20 on a transport vehicle, which is not shown in the Figs., such as a flatbed trailer for example. Next, the volume 25 may be transported to a selected site. When the item is a tree for example, that tree may be replanted in an a priori appropriately prepared implantation excavation

### The Power Unit

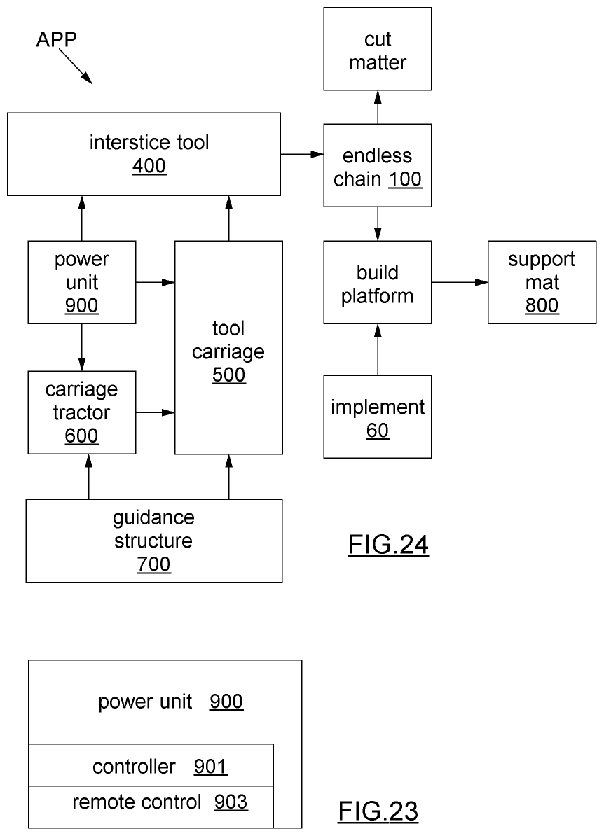

FIG. 23 is a schematic representation of the power unit 900 and of some of the elements included therein.

The power unit 900, may preferably be chosen as an autonomous mobile and transportable standard piece of hydraulic power supply, to operate as a source of hydraulic pressure. The power unit 900 may include a combustion engine for driving a hydraulic pump fed from a hydraulic oil container, and include ancillary equipment.

The power unit 900 is usually disposed at soil top level 0, thus out of the trench 30. Hydraulic oil pressure is supplied to both the hydraulic motor 303 of the interstice device 400, and to the hydraulic tractor motor 605 of the carriage tractor 600. Alternatively, the apparatus APP may be configured for use of electric power if desired.

The power unit 900 may include a controller 901, which may be programmed, and which may be remotely operated by use of a remote-control device 903.

### Operation of the Apparatus

The apparatus APP may be operated by one or more operators, which is/are not shown in the Figs.

As a preliminary step, the operator has to select the size of the support structure 700 to be used and has to decide how deep to select the depth of cut 27, which depth or cut 27 dictates the bottom depth 31 of the trench 30 to be disposed deeper below the depth of cut 27. Next, the trench 30 is dug and the beams of the support structure 700 have to be assembled, out of the trench 30 or on the bottom depth 31 thereof. The trench 30 may be dug in the shape of a straight angled quadrilateral which encompasses a mass of soil 24 which is supported on the bottom depth 31 of the trench 30.

The tool carriage 500 may preferably be mounted on the beams 707 and 709 before assembly of the support structure 700. The interstice tool 400 may then be assembled to bridge the tool carriage 500. At this stage, hydraulic pressurized oil supplied by the power unit 900 may be coupled to the carriage tractor 600 and to the interstice tool 400, whereby the apparatus APP may be operated.

Once the power unit 900 provides hydraulic pressure, the repetitive two steps sequence of liberation of the volume 25 from the soil 21 and building of the platform 800, may begin. By translation of the interstice tool 400 towards the mass 24 of soil 21, a first span of interstice 51 is cut as shown in FIG. 13, and the cutting operation is stopped.

Next, an implement 60 is coupled to the cutting links 105 of the chain trailing flank 207 shown in FIG. 18, by use of an implement fastener 70, shown as a coupling pin in FIG. 19. In turn, the stopped from translation interstice tool 400 is operated to drag the coupled implement 60 from the trench 703, through the interstice 50, and when out into the trench 705, the interstice tool 400 is stopped and the implement fastener 70 is released from the chain trailing flank 207. Thereby, the first implement 60.i, shown in FIGS. 14 and 15 has been inserted and the first sequence of alternating ‘cut soil 21 and matter 29, and clear away debris thereof, and insert implement 60’ is accomplished. The alternating sequence of operations of the interstice tool 400 intermittent and is repeated until the cutting mechanism 200 exits out into the trench 39 and the support platform 800 is completed. It suffices now to couple the implements 60 to the hoisting equipment 803 by coupling means, and remove the tree or other item(s) 20 together with the volume 25 of soil 21 supported on the platform 800.

It is noted that the distance which separates apart between the implements 60 depends on the consistency and type of soil 21. For sand for example the implements 60 may be disposed in mutual, or nearly so. Still for sand, the soil may be wetted, say with water, or by use of construction foam which rigidizes in contact with air. Thereby, the volume 25 of soil 21, and/or the quasi vertical walls 22 may be reinforced and rigidized.

It is further noted that when practical, the apparatus APP may be used to insert implements 60 which are not belts 60, but are articles 60 like pipes, cables, and other similar articles, through the volume 25, without removal and hoisting away of the volume 25. Thus, an implement 60, or an article 60, may be dragged to extend between and out of two opposed trenches 30, at a depth of cut 27. Such an article may be releasably tied or releasably coupled mechanically to a link 103 of the chain trailing flank 207, or to the pull opening 119 of a cutting link 105. Although different from the coupling of a belt 61, such mechanical coupling depends on the nature of the selected implement 60 and needs not to be described and depicted to those skilled in the art.

There have thus been described an apparatus APP and a method for constructing an apparatus for the removal of in soil 21 embedded item(s) 20.

The apparatus APP has an interstice tool 400 operative to cut through a volume 25 of soil 21 and out of a selected mass 24 of soil 21. The interstice tool 400 is further operative to build a support mat 800 in the interstice 50 under the bottom surface 23 of the volume 25 for the support and removal, by hoisting away of the volume 25 of soil 21.

The mass 24 of soil 21 has the general approximate shape of a vertical normal parallelepiped, thus square or rectangular cuboid, which may be surrounded by a right-angled quadrilateral trench 30 including four trench sides 33, 35, 37, and 39. The word ‘appropriate’ is meant to indicate for example, that surfaces of the trench 30, like walls 22 thereof, and the mass 24, do not present surfaces in the sense of theoretical geometric terms, but are rather a quasi-approximation since being dug and formed in or by soil 21 and not cut in a rigid material. For example, a vertical wall 22 may be a quasi-vertical wall 22 which is not a vertical geometric plane, but an approximation thereof.

The main elements for the apparatus APP that are supported by the guidance structure 700 include the interstice tool 400, the tool carriage 500 and the carriage tractor 600. Each one of those main elements may be reversibly disassembled from the apparatus APP, and each one of those main elements may be reversibly disassembled into smaller element portions.

### REFERENCE SIGNS LIST

| # | Name | FIG. |
|---|---|---|
| APP | apparatus | 24 |
| 0 | soil top level | 2 |
| CL | centerline of carriage tractor 600 | 10 |
| CW | clockwise | 18 |
| DIR | direction | 19 |
| i | integer i out of n | 10 |
| 20 | item(s) 20, 20a, 20b | 12 |
| 11 | bottom depth of item 20 | 12 |
| 21 | soil | 11 |
| 22 | quasi-vertical trench walls | 2 |
| 23 | bottom surface 23 of the volume 25 | 2 |
| 24 | block or mass of soil | 2 |
| 25 | volume | 2 |
| 27 | depth of cut 27, cut depth | 2 |
| 29 | matter or material of item(s) | 12 |
| 30 | trench | 1 |
| 31 | trench 30 bottom depth | 2 |
| 33 | trench first side | 1 |
| 35 | trench second side | 1 |
| 37 | trench third side | 2 |
| 39 | trench fourth side | 2 |
| 50 | interstice | 13 |
| 51 | first span of interstice | 12 |
| 53 | second span of the interstice | 15 |
| 55 | gap | 13 |
| 60 | implement or article | 17 |
| 60.i | implement 60.i of 60.n | 16A |
| 61 | support belt, belt | 17 |
| 62 | belt thickness | 17 |
| 63 | belt width | 17 |
| 64 | belt opening | 17 |
| 65 | belt end | 17 |
| 66 | belt length | 17 |
| 70 | implement fastener | 19 |
| 71 | coupling pin | 19 |
| 72 | short leg | 19 |
| 73 | long leg | 19 |
| 74 | belt front portion | 19 |
| 75 | leading plate | 20 |
| 76 | mechanical fastener | 20 |
| 77 | hoisting opening | 20 |
| 100 | endless chain | 3 |
| 101 | chain section | 3 |
| 103 | links | 3 |
| 105 | cutting link | 3 |
| 107 | coupling link | 3 |
| 109 | open link | 3/ |
| 111 | clearing link | 3 |
| 113 | cutting tooth | 3 |
| 115 | clearing tooth | 3 |
| 117 | drive opening | 3 |
| 119 | pull opening | 3 |
| 200 | cutting mechanism | 4 |
| 201 | sprocket wheel | 4 |
| 203 | endless chain flank | 4 |
| 205 | chain leading flank | 16 |
| 207 | chain trailing flank | 16 |
| 300 | cutting drive | 5 |
| 303 | hydraulic motor | 5 |
| 305 | mechanical gearbox | 5 |
| 400 | interstice tool | 5 |
| 500 | tool carriage | 8 |
| 501 | trailed cart | 8 |
| 503 | cart wheel | 8 |
| 505 | cart body | 8 |
| 507 | cart wheel axle | 9 |
| 600 | carriage tractor | 10 |
| 601 | tractor winch | 10 |
| 603 | winch base | 11 |
| 605 | hydraulic tractor motor | 11 |
| 607 | tractor gearbox | 11 |
| 610 | tractor shaft | 10 |
| 611 | shaft end portion | 10 |
| 613 | tractor drum | 10 |
| 615 | shaft support | 11 |
| 617 | tractor belt | 10 |
| 700 | guidance structure | 6 |
| 701 | beam | 6 |
| 703 | first beam | 10 |
| 704 | lateral beam | 10 |
| 705 | second beam | 10 |
| 707 | third beam | 6 |
| 708 | longitudinal I-beam | 10 |
| 709 | fourth beam | 10 |
| 711 | U-beam | 7 |
| 713 | web of beams | 7 |
| 715 | channel | 7 |
| 717 | top flange | 8 |
| 719 | bottom flange | 8 |
| 800 | support platform 800 or mat | 24 |
| 803 | hoisting equipment or crane | 22 |
| 805 | hosting ropes | 22 |
| 807 | attachment device | 22 |
| 809 | hoisting direction | 22 |
| 900 | hydraulic power unit | 23 |
| 901 | controller | 23 |
| 903 | remote control device | 23 |

1. An apparatus for removal of in soil embedded item(s), the apparatus comprising:
an interstice tool with a cutting mechanism configured to cut an interstice in a mass of soil, including the item(s), and encompassed by a trench having a trench bottom depth on which the mass is supported, wherein the interstice is cut a cut depth selected below top soil level and above the trench bottom depth, and
the interstice tool is further configured to insert an implement into and throughout of the interstice.

2. The apparatus of claim 1, wherein the cutting mechanism is configured to cut through matter including at least roots, wood, soil, stone, rock, concrete, and steel.

3. The apparatus of claim 1, wherein the trench, which is dug in the soil in the shape of a right-angled quadrilateral, has approximately vertical trench walls.

4. The apparatus of claim 1, wherein a guidance structure having a right-angled quadrilateral footprint, is configured for disposition at the trench bottom depth, wherein the guidance structure is configured to support and guide motion of the interstice tool.

5. The apparatus of claim 1, wherein a guidance structure having a right-angled quadrilateral footprint, is configured for disposition at the trench bottom depth, and wherein the guidance structure is further configured to support a tool carriage configured to provide wheeled translation of the interstice tool.

6. The apparatus of claim 1, wherein a guidance structure having a right-angled quadrilateral footprint, is configured for disposition at the trench bottom depth, and wherein the guidance structure is configured to support a carriage tractor configured to drive the interstice tool into translational motion.

7. The apparatus of claim 1, wherein a guidance structure having a right-angled quadrilateral footprint, is configured for disposition at the bottom depth of the trench, wherein the guidance structure has two parallel beams, each one of the two beams being configured to support a tool carriage thereon, and wherein the interstice tool is supported in bridging disposition over the tool carriages.

8. The apparatus of claim 1, wherein the interstice tool is configured to operate in successive sequences of two alternating steps of cutting soil and item(s') matter and clearing away of debris thereof, and of implement(s) insertion.

9. The apparatus of claim 1, wherein the interstice tool comprises
an endless chain having a chain leading flank, which is configured to cut and clear away debris, and
a chain trailing flank configured for implements insertion in the interstice.

10. The apparatus of claim 1, wherein the interstice tool is configured to build a support mat in the interstice.

11. A method for construction of an apparatus for removal of in soil embedded item(s), the method comprising:
assembling four beams, into a right-angled quadrilateral shape to form a support and guidance structure configured for disposition in a trench at trench bottom depth, wherein the trench is compliant with the shape of the support and guidance structure, and flanks a mass of soil disposed on the bottom depth,
providing a tool carriage and supporting thereon of an interstice tool disposed in bridging disposition over two parallel beams,
providing the interstice tool with a cutting mechanism, for cutting through soil and matter, and for cutting an interstice at a selected cut depth, below a top soil depth and above the trench depth, to cut a bottom surface for separating apart between a volume of soil and the mass of soil, and
mounting a carriage tractor on one of two parallel beams, and coupling thereof to the tool carriage for driving the interstice tool in cutting translation, for intermittent cutting operation and insertion of implement(s) in the interstice, to form a support platform for removal and hoisting away of the volume.

12. The method of claim 11, wherein the beams of the support and guidance structure are configured to:
provide a rigid structure when assembled, and
allow assembly and disassembly in situ.

13. The method of claim 11, wherein the tool carriage comprises a hydraulic motor for providing rotative motion to a gearbox which drives the cutting mechanism into motion.

14. The method of claim 11, further comprising:
providing the cutting mechanism with an endless chain, and
supporting a plurality of chain sections comprising selected chain links including at least a cutting link and a clearing link.

15. The method of claim 14, wherein the endless chain is provided with at least a cutting tooth and a drive opening.

16. The method of claim 11, further comprising inserting into an interstice of an implement configured for one of: coupling to hoisting equipment, and providing a channeling passage.

17. The method of claim 11, wherein the cutting mechanism with an endless chain having a chain leading flank for cutting soil and matter and clearing away cut debris, and a chain trailing flank for inserting implement(s) into and throughout of the interstice.

18. The method of claim 11, wherein the cutting mechanism has two sprocket wheels coupled by an endless chain, wherein each one sprocket wheel is driven by a hydraulic motor at a same hydraulic fluid pressure, to provide tension to both a chain leading flank and a chain trailing flank.

19. The method of claim 11, further comprising:
providing two trailed carts, wherein each one of which is mounted in riding disposition on one of the parallel beams, and
supporting the interstice tool in bridging disposition on the two trailed carts.

20. The method of claim 19, further comprising:
providing the carrier tractor with a tractor winch, and
providing the tractor winch with two tractor belts, each one belt of which is coupled to one of the trailed carts.
